(19) United States
(12) Patent Application Publication
(10) Pub. No.: US 2010/0136286 A1
(43) Pub. Date: Jun. 3, 2010

(54) COVERING FOR PAPER MACHINE

(76) Inventors: Frank Bez, Heidenheim (DE); Petra Hack-Ueberall, Reutlingen (DE); Matthias Hoehsl, Heidenheim (DE); Matthias Schmitt, Munchen (DE); Michael Straub, Mittelstadt (DE)

Correspondence Address: TAYLOR & AUST, P.C., P.O. Box 560, 142. S Main Street, Avilla, IN, 46710, US

(21) Appl. No.: 12/626,071

(22) Filed: Nov. 25, 2009

Related U.S. Application Data
(63) Continuation of application No. PCT/EP2008/052596, filed on Mar. 4, 2008.

(30) Foreign Application Priority Data
May 29, 2007 (DE) DE 102007024847.6

(51) Int. Cl. B32B 3/10; B32B 38/10

(52) U.S. Cl. 428/137; 156/77

(57) ABSTRACT

A covering for use with a paper, cardboard, tissue or fibrous web making machine, the covering including a plurality of films laminated together, the films including a polymer material. The plurality of films each having a plurality of perforations penetrating a thickness of each film. The perforations being configured to form drainage channels through the covering. At least one of the films having perforations had filler particulates distributed through the polymer material of the film. The filler particulates having been substantially removed from the polymer material to form the perforations in the films.

### CROSS REFERENCE TO RELATED APPLICATIONS

This is a continuation of PCT application No. PCT/EP2008/052596, entitled “PAPER MACHINE COVERING”, filed Mar. 4, 2008, which is incorporated herein by reference.

### BACKGROUND OF THE INVENTION

1. Field of the Invention

The present invention relates to a covering for a paper, cardboard or tissue machine and a method for making the covering.

2. Description of the Related Art

There have been many attempts to improve the manufacturing process of coverings for paper machines, in particular regarding production costs and flexibility. A possible approach to resolve this issue, such as described in U.S. Pat. No. 4,541,895, considered the provision of coverings, built up by a plurality of laminated sheets. A disadvantage of this type of covering for paper machines results from the complex technologies needed to provide drainage channels by perforating each layer or film, e.g. by laser drilling or other expensive methods. Laser drilling requires discrete perforations in each layer or film, which requires a long time to make and produces perforations that form recurring patterns. Recurring patterns of the drainage channels on the coverings of paper machines have the distinct disadvantage of leaving strong markings on the paper which they produce. There are other methods conceivable to produce such perforations, e.g. by applying laser light through masks, but even this will result in recurring perforation patterns.

What is needed in the art is a covering that is easy to produce and does not produce drainage channel perforations that appear in recurring patterns.

### SUMMARY OF THE INVENTION

The present invention provides a covering for a paper, cardboard or tissue making machine, the covering consisting of multiple films made out of polymers that are laminated together. Each of the laminated films contains a plurality of perforations which extend across the thickness of each respective film. The perforations of each of the different films form drainage channels and are oriented with respect to one another so that a fluid can escape through the covering.

The covering according to the present invention is characterized by at least one perforated film that is made out of a polymer material with a filler additive. The film is originally unperforated. Perforations are subsequently introduced into the film by removing the filler additive from the polymer.

In other words, a film is made without perforations out of a composite material that contains the polymer and a partially embedded filler material. The perforated film is then formed by removing the filler material from the unperforated film.

Ultimately, perforations are created in the film by providing a material that partially consists of a filler material, which is subsequently removed leaving cavities that form the perforations.

By including at least one film made out of the polymer and the later to be removed filler material, there are, besides the nature of the materials and distribution of the admixed filler, nearly unlimited possibilities in the simple and flexible formation of perforations in the film with regard to the number, size, distribution and form. In this way the present invention allows for a particularly inexpensive and flexible way to produce the intended kind of covering.

There are a number of diverse materials conceivable to be used as fillers and a variety of methods can be used to subsequently remove these fillers from the film. In very general terms, the fillers may be removed from the film by evaporation, by dissolving, e.g. leaching, or by melting them out of the film.

The filler material in at least one of the films consists of filler particulates. The filler may consist of filler particles of principally different materials. Furthermore, the filler particles may be of different sizes and shapes.

A variation of the present invention includes a filler material to be removed from the film under the influence of electromagnetic radiation, for example, by the use of laser light. In this case, the filler material may have a higher absorptivity than the film material so that under the influence of the radiation most of the energy is absorbed by the filler material and not the polymer, causing the filler material to evaporate or melt leaving perforations in the film.

Another variation of the present invention includes a filler material which dissolves, e.g. under the influence of a chemical solvent and is thus removed from the film. As an example, NaCl may be a filler material, which can be simply dissolved in water and thus removed from the film creating perforations.

The filler particles may further extend at least across the thickness of the film. This supposes that the size of the filler particles match, at least in one orientation, the thickness of the film thickness. If only the maximum extension of the filler particles matches or exceeds the thickness of the film, and is otherwise less, then the filler particles will need to be aligned along this direction across the film thickness. Alternatively, the filler particles, may be sized such that they exceed the film thickness in any orientation.

Alternatively, or in addition to previous considerations, perforations may form as the result of removing multiple filler particles that cluster together, i.e. forming agglomerates. In this instance, the respective agglomerates of filler particulates may extend across the thickness of the film.

The filler particulates may furthermore have high aspect ratios, i.e. longer in one direction than in others, be spherical or cylindrical in shape. It is furthermore conceivable that the filler particles have random and arbitrary shapes.

The shape of the perforations and, therefore, the shape of the drainage channels can be affected by the shape as well as the orientation of the filler particles. The orientation of the filler particles will conceivably have particularly strong influence over the shape and morphology of the perforations as they deviate from a spherical shape or display decreasingly less levels of point symmetry, i.e. if the shape is increasingly elongated.

Some or even all films of the covering that are made from polymer material may be admixed with filler particulates as unperforated films, but can then become perforated by subsequent removal of the filler material.

The present invention allows modification of the perforations in the films that form the coverings to an almost arbitrary extent. A further development of the present invention provides at least one film to be made with perforations of varying sizes by using filler particles of variable sizes.

The coverings according to the present invention may include a plurality of films whose perforations are made by removing filler particles that were previously embedded in the polymer material. The perforations in the various films may be of varying sizes. The present invention may further contain at least two films that are perforated by removal of filler particles and the size of the perforations in one of the films may be different than the size of the perforations in the other such fashioned film. This can be achieved, e.g. by using different sizes of filler particles in one film than the size of filler particles in the other film. Typical sizes of filler particles range from about 20 μm up to 400 μm.

The structure of the drainage channels inside the covering according to the present invention can be further influenced if in at least two of the films where the perforations are made by subsequent removal of filler particles, the number of perforations in one of the films is different than the number of perforations in the other such made film. This can be achieved, e.g. by mixing a different amount of filler particles in one of the films than the amount of filler particles admixed in the other such film.

The drainage structure can be further impacted if, in at least two of the films where the perforations are made by subsequent removal of filler particles, the shape of the perforations in one of the films is different than the shape of the perforations in the other such film. This can be achieved, e.g. by mixing filler particles of a different shape in one of the films than the shape of filler particles admixed in the other such film.

The present invention further provides that at least one film where the perforations are made by subsequent removal of filler particles, the filler particles in one film may be made out of two different materials. It is also conceivable that the filler particles in one film are made of a different material than the filler particles in one of the other films.

The present invention further provides a covering in which the upper film touching the layer of paper, also known as the paper side film, and the lower film in contact with the paper machine, also known as the machine side film, are both perforated by subsequent removal of previously embedded filler particles and the perforations in the upper film are smaller than the perforations in the lower film and/or the number of perforations in the upper film is larger than the number of perforations in the lower film. For example, the filler particles used on the upper film may range from approximately 30 μm up to approximately 400 μm while the filler particles used on the lower film may range from approximately 40 μm up to approximately 400 μm.

In yet another embodiment of the covering of the present invention, the covering includes a woven or fabric-like surface structure and/or a thread or fiber fabric, also known as a yarn sheet or textile. The textile surface structure in this context includes, but is not limited to, woven textiles or tissue, knitted fabrics or hosiery, and shear wool, fleeces or non-woven formed fabric. The woven or fabric-like structure and/or thread or fiber fabric can be used to reinforce the covering proposed by the present invention.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIGS. 1a and 1b illustrate an embodiment of a method to produce a covering of the present invention; and

FIG. 2 is a sectional illustration of the covering produced using the method of FIGS. 1a and 1b.

Corresponding reference characters indicate corresponding parts throughout the several views. The exemplifications set out herein illustrates an embodiment of the invention in one form and such exemplification is not to be construed as limiting the scope of the invention in any manner.

### DETAILED DESCRIPTION OF THE INVENTION

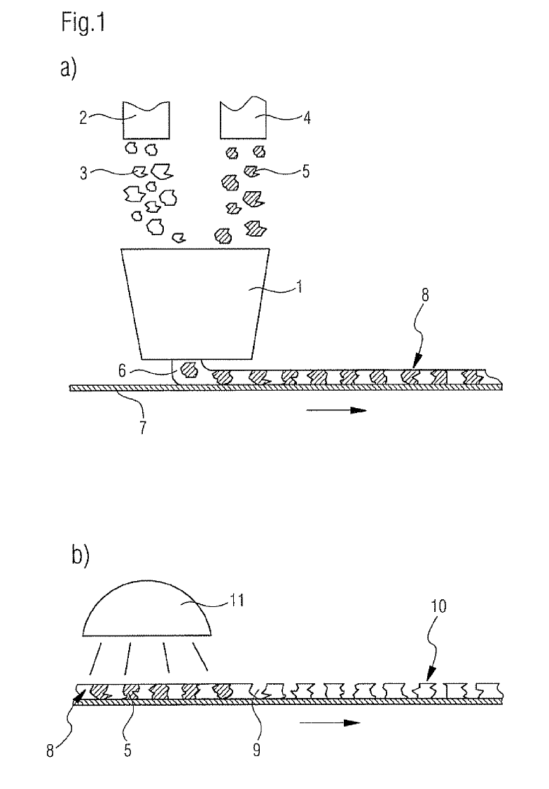

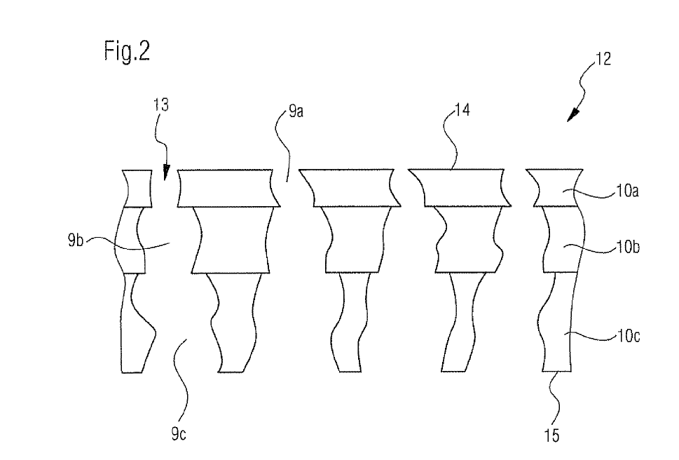

Referring now to the drawings, more particularly to FIG. 1a, there is shown a method according to the present invention to produce a cover 12 (FIG. 2) for a papermaking machine. Cover 12 may also be known as clothing 12, a forming sieve 12, a press belt 12 or a drying sieve 12. According to the method illustrated in FIG. 1a, an extrusion device 1 is fed a polymer material 3 from a metering device 2, as well as filler particulates 5 from a metering device 4. Polymer material 3 and filler particulates 5 are mixed together and extruded as an extruded product 6 from extrusion device 1. Particulates 5 can also be injected into polymer material 3 prior to extrusion through extrusion device 1. Extruded product 6, which includes polymer 3 and filler particulates 5, is moved on conveyor belt 7 in the form of an unperforated film, 8.

FIG. 1b depicts the subsequent step where perforations 9 are created in film 8, which extend across the entire thickness of the film. In order to create perforations 9, filler particulates 5 are removed from film 8, thus creating perforated film 10.

In this embodiment of the present invention, filler material 5 has a higher absorptivity of laser light (e.g. in the spectrum of 10 μm or perhaps 250-200 nm) than polymer material 3 so that it is possible to remove filler particulates 5 under the influence of laser light 11, from unperforated film 8, e.g. by evaporation, thereby forming perforated film 10.

FIG. 2 depicts covering 12, for use in a papermaking machine as, for example, a forming sieve, including three perforated films 10a, 10b, and 10c, all of which are produced in the fashion described in FIGS. 1a, 1b.

Film 10a has a thickness of, for example, 0.08 mm and includes a plurality of perforations 9a, all of which extend across the entire thickness of film segment 10a. Film 10b has a thickness of, for example, 0.18 mm and includes a plurality of perforations 9b, all of which extend across the entire thickness of film segment 10b. Film 10c has a thickness of, for example, 0.2 mm and includes a plurality of perforations 9c, all of which extend across the entire thickness of film segment 10c.

Film segment 10a constitutes the upper layer of covering 12 and it further constitutes paper side surface 14. Furthermore, film segment 10c constitutes the lower film of covering, 12, i.e. the machine side surface 15.

Films 10a through 10c are all laminated onto one another, whereby perforations 9a through 9c of the different films 10a through 10c are arranged towards each other in such a way that they form drainage channels 13 that extend all the way from paper side 14 to machine side 15.

As depicted in FIG. 2, the sizes of perforations 9a through 9c vary such that perforations 9a in the upper layer are smallest and perforations 9c are largest of the layers of the covering 12.

It is furthermore depicted that perforations 9a in upper layer 10a were produced by the removal of previously embedded spherical filler particles, as opposed to perforations 9c in lower layer 10c, which were produced by the removal of previously embedded, randomly shaped filler particles.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A covering for use with one of a paper, cardboard, tissue and fibrous web making machine, the covering comprising a plurality of films laminated together, said films including a polymer material, said plurality of films each having a plurality of perforations penetrating a thickness of each said film, said perforations being configured to form drainage channels through the covering, at least one of said films having said perforations having had filler particulates distributed through said polymer material of said at least one said film, said filler particulates having been substantially removed from said polymer material to form said perforations in said at least one of said films.

2. The covering of claim 1, wherein said filler particulates extend entirely through said thickness of at least one of said films prior to removal of said filler particulates.

3. The covering of claim 2, wherein said filler particulates are composed of a material removable by electromagnetic radiation.

4. The covering of claim 3, wherein said electromagnetic radiation is a laser light, said filler particulates having a larger absorptivity of said laser light than an absorptivity of said polymer material.

5. The covering of claim 4, wherein more than one of said plurality of films includes said perforations, said perforations having been formed by injection of said filler particulates into said polymer, said filler particulates having been subsequently removed from said polymer material after said polymer material solidified.

6. The covering of claim 5, wherein said filler particulates include a first set of filler particulates and a second set of filler particulates, said first set of filler particulates being used in at least one of said plurality of films has a size different from said second set of filler particulates used in an other of said plurality of films.

7. The covering of claim 1, wherein said plurality of films include a first film and a second film, said first film having a first set of perforations of a first size, said second film having a second set of perforations of a second size, said first size being different from said second size.

8. The covering of claim 7, wherein said first film has a first number of said perforations therein, said second film having a second number of said perforations therein, said first number being greater than said second number.

9. The covering of claim 8, wherein said first set of perforations have a first shape, said second set of perforations having a second shape, said first shape being different from said second shape.

10. The covering of claim 1, wherein said plurality of films includes a paper side film and a machine side film, said paper side film having a first set of perforations therein, said machine side film having a second set of perforations therein, said first set of perforations having a first diameter, said second set of perforation having a second diameter, said first diameter being smaller than said second diameter, said first set of perforations having a higher number of said perforations than said second set of perforations.

11. The covering of claim 10, wherein said filler particulates include a plurality of different materials.

12. The covering of claim 11, wherein said plurality of films include a first film and a second film, said filler particulate material used in said first film being different from said filler particulate material used in said second film.

13. The covering of claim 1, wherein the covering includes one of a woven and a non-woven fabric associated with said plurality of films.

14. The covering of claim 1, wherein the covering is one of a forming sieve, a press belt and a drying sieve.

15. A method of producing a covering for use with one of a paper, cardboard, tissue and fibrous web making machine, the method comprising the steps of:
admixing a filler particulate with a polymer material thereby forming a mixture;
forming a plurality of films from said mixture;
laminating said plurality of films together; and
forming a plurality of perforations in each of said films by removing said filler particulate from said polymer material of each of said films, wherein said plurality of perforations in each of said films extends through a thickness of each of said films to form a plurality of drainage channels through said plurality of films.
